(19) United States
(12) Patent Application Publication
(10) Pub. No.: US 2008/0092075 A1
(43) Pub. Date: Apr. 17, 2008

(54) METHOD OF BUILDING A DATABASE OF A LIGHTING CONTROL SYSTEM

(76) Inventors: Joe Suresh Jacob, Macungie, PA (US); Audwin W. Cash, Bethlehem, PA (US); Christopher J. Rigatti, Philadelphia, PA (US)

Correspondence Address: OSTROLENK FABER GERB & SOFFEN, 1180 AVENUE OF THE AMERICAS, NEW YORK, NY, 100368403, US

(21) Appl. No.: 11/870,783

(22) Filed: Oct. 11, 2007

Related U.S. Application Data
(60) Provisional application No. 60/851,383, filed on Oct. 13, 2006.
(60) Provisional application No. 60/858,844, filed on Nov. 14, 2006.

(51) Int. Cl. G06F 15/16; G06F 3/048

(52) U.S. Cl. 715/771; 709/206; 715/764

(57) ABSTRACT

A lighting control system is operable to control the amount of power delivered to a plurality of electrical loads. The lighting control system includes load control devices (such as digital electronic dimming ballasts), motorized window treatments, controllers, lighting hubs, and personal computers. The personal computer is preferably executing a graphical user interface (GUI) software, which allows a user to configure and monitor the operation of the lighting control system. The personal computer is operable to automatically discover the control devices of the lighting control system and to build a programming database for use in the GUI software. The personal computer is further operable to update portions of the programming information in the control devices of the lighting control system.

### RELATED APPLICATIONS

This application claims priority from commonly-assigned U.S. Provisional Application Ser. No. 60/851,383, filed Oct. 13, 2006, and U.S. Provisional Application Ser. No. 60/858,844, filed Nov. 14, 2006, both entitled LIGHTING CONTROL SYSTEM. The entire disclosures of both applications are hereby incorporated by reference.

### BACKGROUND OF THE INVENTION

1. Field of the Invention

The present invention relates to a load control system comprising a plurality of load control devices for controlling the amount of power delivered to a plurality of electrical loads from an AC power source, and more particularly, to a procedure for building a database of a lighting control system for controlling the intensity of a plurality of lighting loads.

2. Description of the Related Art

Typical load control systems are operable to control the amount of power delivered to an electrical load, such as a lighting load or a motor load, from an alternating-current (AC) power source. A load control system generally comprises a plurality of control devices coupled to a communication link to allow for communication between the control devices. The control devices of a lighting control system include load control devices operable to control the amount of power delivered to the loads in response to digital messages received across the communication link or local inputs, such as user actuations of a button. Further, the control devices of a lighting control system often include one or more keypad controllers that transmit commands across the communication link in order to control the loads coupled to the load control devices. An example of a lighting control system is described in greater detail in commonly-assigned U.S. Pat. No. 6,803,728, issued Oct. 12, 2004, entitled SYSTEM FOR CONTROL OF DEVICES, which is incorporated herein by reference.

FIG. 1 is a simplified block diagram of a prior art lighting control system 10 according to the present invention. The lighting control system comprises a power panel 12 having a plurality of load control modules (LCMs) 14 (i.e., load control devices). Each load control module 14 is coupled to a lighting load 16 (or another type of electrical load, such as a motor load) for control of the amount of power delivered to the lighting load. Alternatively, each load control module 14 may be coupled to more than one lighting load 16, for example, four lighting loads, for individual control of the amount of power delivered to each of the lighting loads. The power panel 12 also comprises a module interface (MI) 18, which controls the operation of the load control modules 14 via digital signals transmitted across a power module control link 20

The lighting control system 10 further comprises a processor 22, which controls the operation of the lighting control system and thus the amount of power delivered to the lighting loads 16 by the load control modules 14. The processor 22 is operable to communicate with the module interface 18 of the power panel 12 via a power panel link 24. Accordingly, the module interface 18 is operable to cause the load control modules 14 to turn off and on and to control the intensity of the lighting loads 16 in response to digital messages received from the processor 22. The processor 22 is operable to be coupled to a plurality of power panels via the power panel link 24.

In addition to being coupled to the power panel link 24, the central processor 22 is also coupled to a control station link 26 for communication with a plurality of control stations 28 (i.e., wallstations or keypads). The control stations 28 allow users to provide inputs to the lighting control system 10. The processor 22 is operable to control the lighting loads 16 in response to digital messages received from the control stations 28.

The lighting control system 10 as shown in FIG. 1 further comprises a personal computer (PC) 30 and a second processor 32. The first and second processors 22, 32 are coupled to the PC 30 via an Ethernet link 34 using a standard Ethernet switch 36. The second processor 32 is operable to be coupled to a plurality of power panels (not shown) via a second power panel link 38 and a plurality of control stations (not shown) via a second control station link 40.

The PC 30 executes a graphical user interface (GUI) software that allows a user of the lighting control system 10 to setup and monitor the lighting control system. The user is operable to program the desired operation of the lighting control system 10 using the GUI software of the PC 30, which creates a database of the information defining the desired operation of the lighting control system. For example, the user is operable to determine what types of electrical loads the lighting control system 10 is controlling (e.g., motor loads or lighting loads, such as incandescent lamps, fluorescent lamps, or electronic low-voltage transformers), what types of load control modules 14 (or other load control devices) are required to control the electrical loads, and how many processors 32 are required. Further, the user is able to determine what control stations 28 are included in the lighting control system 10 and how the electrical loads respond to actuations of the buttons of the control stations.

In response to the programming information provided by the user using the GUI software, the PC 30 creates a PC database defining the desired operation of the lighting control system 10. After generating the PC database, the PC 30 compiles the downloads all or a portion of the compiled database to the processors 22, 32 and the module interface 18. Accordingly, the lighting control system 10 is now able to operate properly.

The procedure of configuring the lighting control system 10 can be a tedious process, particularly, the step of determining what type and how many processors 32, power panels 12, and load control modules 14 are included in the lighting control system 10. Thus, there exists a need for a procedure for easily and automatically building a database for a lighting control system, where the database includes the number and type of the control devices of the lighting control system.

### SUMMARY OF THE INVENTION

According to the present invention, a method of building a database of a load control system having a plurality of control devices comprises the steps of: transmitting a query message to the plurality of control devices, receiving device information including an address and a type of one of the plurality of control devices in response to the query message, and storing the addresses and types of the plurality of control devices in the database. Preferably, the method also provides for transmitting a first parameter query message to a first control devices having a first address stored in the database, receiving a response to the first parameter query message that includes a first parameter of the control device having the first address, and storing the first parameter for the control device having the first address in the database.

According to another embodiment of the present invention, a control device for a load control system having a plurality of control devices, each characterized by an address and a type, comprises (1) means for transmitting a query message to the plurality of control devices; (2) means for receiving device information of one of the plurality of control devices in response to the query message, where the device information including the address and the type of the control device; and (3) means for storing the addresses and types of the plurality of control devices in the database.

The present invention further provides a method of building a system programming database defining the operation of a load control system including a server operable to communicate with a plurality of controllers. Each of the controllers is coupled to a plurality of control devices characterized by a device parameter. The method comprises the steps of: (1) transmitting a first query message from each of the controllers to each of the plurality of control devices; (2) transmitting the device parameter of each of the plurality of control devices to the controllers in response to the query messages; (3) adding the device parameter of the each of the plurality of control devices to partial programming databases stored in each of the controllers; (4) transmitting a second query message from the server to each of the controllers; (5) transmitting the partial programming database of each of the controllers to the server; and (6) adding the device parameters of the partial programming databases to the system programming database.

In addition, the present invention provides a load control system comprising a plurality of control devices, a plurality of controllers, and a server. Each of the control devices is characterized by a device parameter and is coupled to one of the plurality of controllers. Each of the controllers is operable to transmit a first query message to each of the control devices, receive the device parameters from each of the control devices, and add the device parameters to a partial programming database. The server executes a graphical user interface software and is operable to communicate with the plurality of controllers, such that the server transmits a second query message to each of the controllers, receives the partial programming databases from each of the controllers, and adds the device parameters of the partial programming databases to a system programming database.

Other features and advantages of the present invention will become apparent from the following description of the invention that refers to the accompanying drawings.

### BRIEF DESCRIPTION OF THE DRAWINGS

FIG. 1 is a simplified block diagram of a prior art lighting control system;

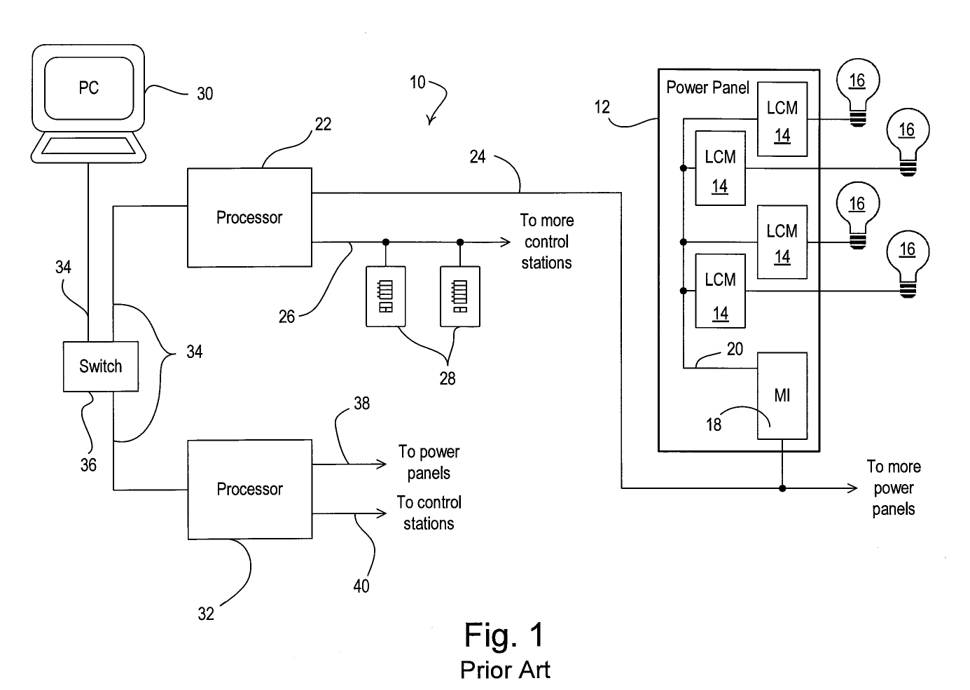

FIG. 2A is a simplified block diagram of a lighting control system according to the present invention;

FIG. 2B is a simplified block diagram of an digital electronic dimming ballast of the lighting control system of FIG. 2A;

FIG. 3A is a flowchart of a ballast addressing procedure executed by a controller of the lighting control system of FIG. 2A;

FIG. 3B is a flowchart of ballast database rebuilding procedure executed by a controller of the lighting control system of FIG. 2A;

FIG. 4 is a flowchart of a controller discovery procedure executed at startup by a processor of the lighting control system of FIG. 2A;

FIG. 5A is a flowchart of a first auto-discovery procedure executed by a personal computer of the lighting control system of FIG. 2A;

FIG. 5B is a flowchart of a second auto-discovery procedure executed by the processor of the lighting control system of FIG. 2A;

FIG. 5C is a flowchart of a third auto-discovery procedure executed by the controller of the lighting control system of FIG. 2A;

FIG. 6 is an example screen shot of an auto-discovery screen of the auto-discovery procedure of FIGS. 5A-5C; and

FIG. 7 is a flowchart of a database transfer procedure executed by the personal computer of the lighting control system of FIG. 2A.

### DETAILED DESCRIPTION OF THE INVENTION

The foregoing summary, as well as the following detailed description of the preferred embodiments, is better understood when read in conjunction with the appended drawings. For the purposes of illustrating the invention, there is shown in the drawings an embodiment that is presently preferred, in which like numerals represent similar parts throughout the several views of the drawings, it being understood, however, that the invention is not limited to the specific methods and instrumentalities disclosed.

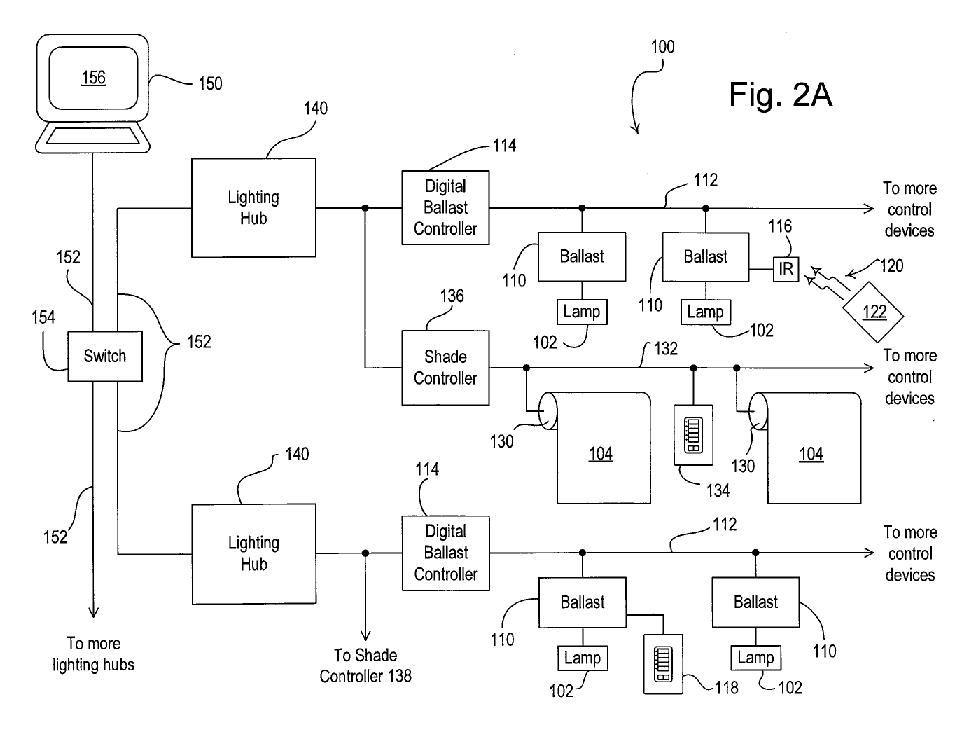

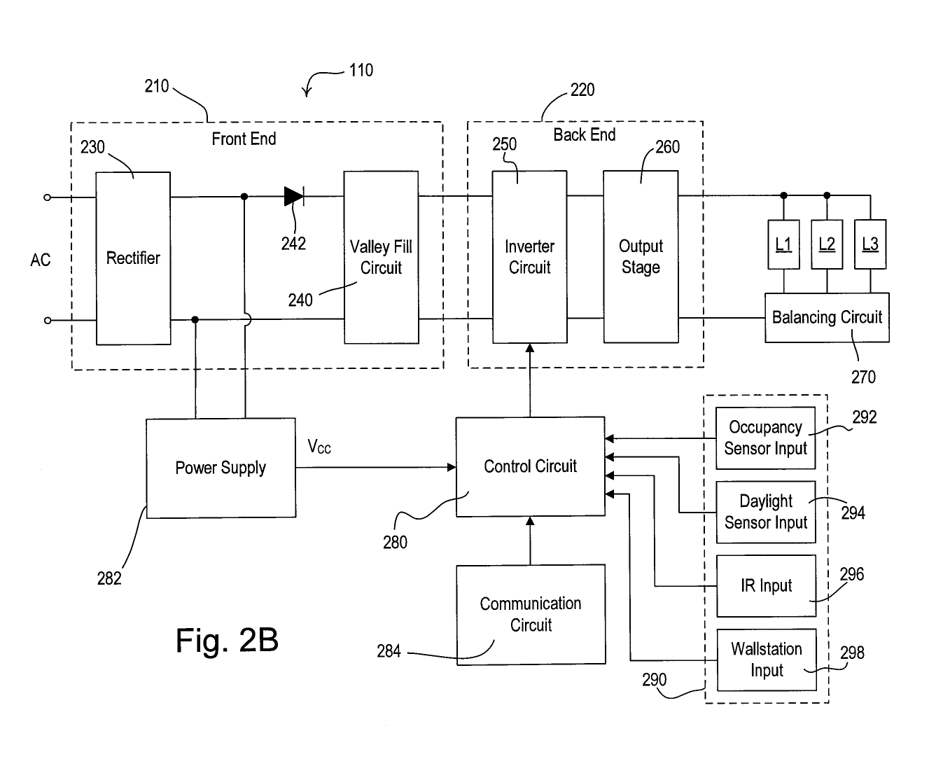

FIG. 2A is a simplified block diagram of a lighting control system 100 according to the present invention. Preferably, the lighting control system 100 is operable to control the level of illumination in a space by controlling the intensity level of the electrical lights in the space and the daylight entering the space. As shown in FIG. 2A, the lighting control system 100 is operable to control the amount of power delivered to (and thus the intensity of) a plurality of lighting load, e.g., a plurality of fluorescent lamps 102. The lighting control system 100 is further operable to control the position of a plurality of motorized window treatments, e.g., motorized roller shades 104, to control the amount of daylight entering the space.

Each of the fluorescent lamps 102 is coupled to one of a plurality of digital electronic dimming ballasts 110 for control of the intensities of the lamps. The ballasts 110 are operable to communicate with each other via digital ballast communication links 112. For example, the digital ballast communication link 112 may comprise a digital addressable lighting interface (DALI) communication link. Each digital ballast communication link 112 is also coupled to a digital ballast controller (DBC) 114, which provides the necessary direct-current (DC) voltage to power the communication link 112 and assists in the programming of the lighting control system 100. Each of the ballasts 110 is operable to receive inputs from a plurality of sources, for example, an occupancy sensor (not shown), a daylight sensor (not shown), an infrared (IR) receiver 116, or a wallstation 118. The ballasts 110 are operable to transmit digital messages to the other ballasts 110 in response to the inputs received from the various sources. Preferably, up to 64 ballasts 110 are operable to be coupled to a single digital ballast communication link 112.

The ballasts 110 may receive IR signals 120 from a handheld remote control 122, e.g., a personal digital assistant (PDA), via the IR receiver 116. The remote control 122 is operable to configure the ballast 110 by transmitting configuration information to the ballasts via the IR signals 120. Accordingly, a user of the remote control 122 is operable to configure the operation of the ballasts 110. For example, the user may group a plurality of ballasts into a single group, which may be responsive to a command from the occupancy sensor. Preferably, a portion of the programming information (i.e., a portion of a programming database) is stored in memory of each of the ballasts 110. An example of the method of using a handheld remote control to configure the ballasts 110 is described in greater detail in co-pending commonly-assigned U.S. patent application Ser. No. 11/375,462, filed Mar. 13, 2006, entitled HANDHELD PROGRAMMER FOR LIGHTING CONTROL SYSTEM, the entire disclosure of which is hereby incorporated by reference.

FIG. 2B is a simplified block diagram of the digital electronic dimming ballast 110, which is driving three fluorescent lamps L1, L2, L3 in parallel comprises a front end 210 and a back end 220. The front end 210 includes a rectifier 230 for generating a rectified voltage from an alternating-current (AC) mains line voltage, and a filter circuit, for example, a valley-fill circuit 240, for filtering the rectified voltage to produce a direct-current (DC) bus voltage. The valley-fill circuit 240 is coupled to the rectifier 230 through a diode 242 and includes one or more energy storage devices that selectively charge and discharge so as to fill the valleys between successive rectified voltage peaks to produce a substantially DC bus voltage. The DC bus voltage is the greater of either the rectified voltage or the voltage across the energy storage devices in the valley-fill circuit 240.

The back end 220 includes an inverter 250 for converting the DC bus voltage to a high-frequency AC voltage and an output circuit 260 comprising a resonant tank circuit for coupling the high-frequency AC voltage to the lamp electrodes. A balancing circuit 270 is provided in series with the three lamps L1, L2, L3 to balance the currents through the lamps and to prevent any lamp from shining brighter or dimmer than the other lamps. The front end 210 and back end 220 of the ballast 110 are described in greater detail in commonly-assigned U.S. Pat. No. 6,674,248, issued Jan. 6, 2004, entitled ELECTRONIC BALLAST, the entire disclosure of which is hereby incorporated by reference.

A control circuit 280 generates drive signals to control the operation of the inverter 250 so as to provide a desired load current to the lamps L1, L2, L3. The control circuit 280 is operable to control the intensity of the lamps L1, L2, L3 from a low-end value to a high-end value. A power supply 282 is connected across the outputs of the rectifier 230 to provide a DC supply voltage V_{CC} which is used to power the control circuit 280. A communication circuit 284 is coupled to the control circuit 280 and allows the control circuit 280 to communicate with the other ballasts 110 on the digital ballast communication link 112. The ballast 110 further comprises a plurality of inputs 290 having an occupancy sensor input 292, a daylight sensor 294, an IR input 296, and a wallstation 298 input. The control circuit 280 is coupled to the plurality of inputs 290 such that the control circuit 280 is responsive to the occupancy sensor, the daylight sensor, the IR receiver 116, and the wallstation 118 of the lighting control system 100.

An example of a digital electronic dimming ballast operable to be coupled to a communication link and a plurality of other input sources is described in greater detail in co-pending commonly-assigned U.S. patent application Ser. No. 10/824,248, filed Apr. 14, 2004, entitled MULTIPLE-INPUT ELECTRONIC BALLAST WITH PROCESSOR, and U.S. patent application Ser. No. 11/011,933, filed Dec. 14, 2004, entitled DISTRIBUTED INTELLIGENCE BALLAST SYSTEM AND EXTENDED LIGHTING CONTROL PROTOCOL. The entire disclosures of both applications are hereby incorporated by reference.

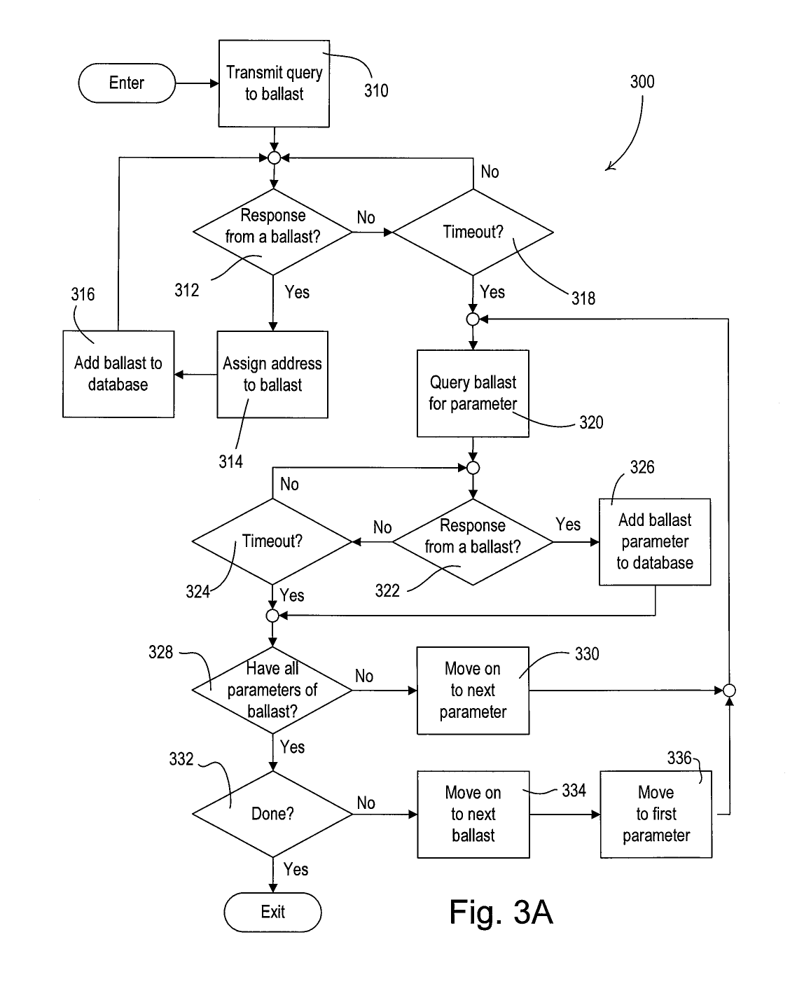

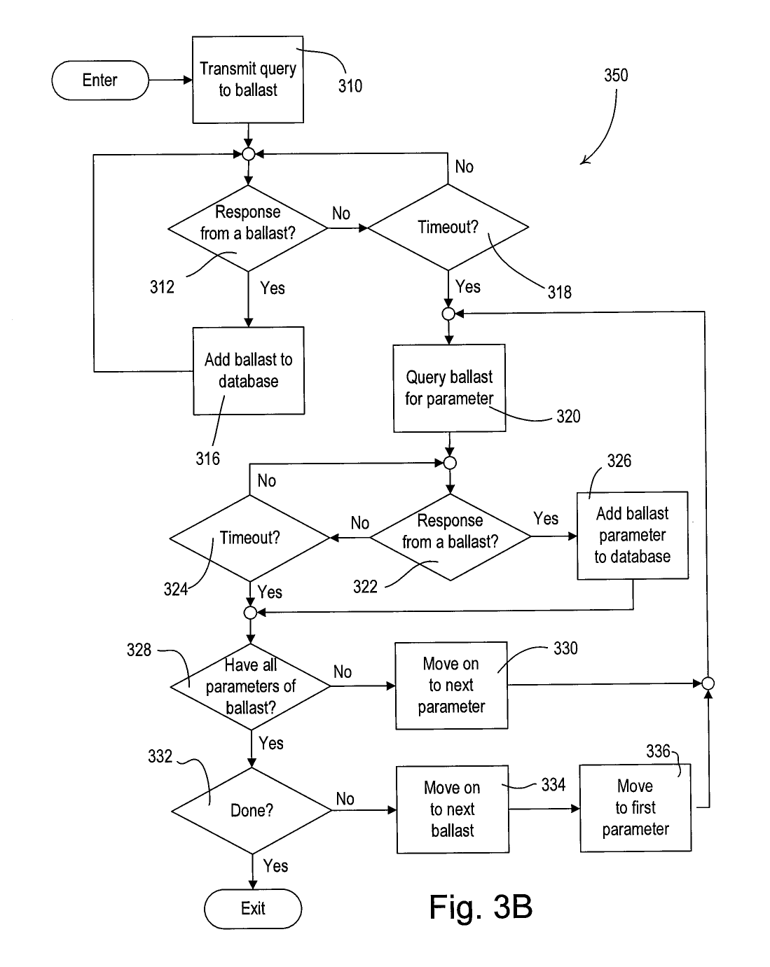

FIG. 3A is a flowchart of a ballast addressing procedure 300 executed by the digital ballast controller 114. The ballast addressing procedure 300 is executed in response to receiving a command to address the ballasts 110, for example, transmitted from the handheld remote control 122. At step 310, the digital ballast controller 114 transmits a query message to all ballasts 110 on the digital ballast communication link 112. If a ballast 110 responds at step 312, the digital ballast controller 114 assigns the ballast a unique link address at step 314. For example, the unique link addresses may comprise numbers between 1 and 64 and the digital ballast controller 114 may assign the unique link addresses in sequential order. At step 316, the digital ballast controller 114 adds the ballast 110 to a ballast database, which is saved in memory in the digital ballast controller. The digital ballast controller 114 continues to address ballasts 110 at step 314 and to add the ballasts to the ballast database at step 316, until a first timeout has expired at step 318.

When the first timeout has expired at step 318, the digital ballast controller 114 queries all of the ballasts 110 in the ballast database for a plurality of ballast parameters, i.e., device information, e.g., the type of and number of lamps connected to the ballast, the rated input voltage, the low-end trim value, the high-end trim value, a serial number, an occupancy sensor light level, and a photosensor gain value. Specifically, the digital ballast controller 114 transmits a “parameter query” message to the first device for the first parameter at step 320. Preferably, the digital ballast controller 114 begins with the first ballast 110 in the ballast database, i.e., having a unique link address of one (1), and sequentially steps through each of the ballasts in the ballast database. Similarly, the digital ballast controller 114 starts with querying for an initial ballast parameter and steps through each of the ballast parameters for a single ballast before querying a different ballast for its parameters.

The ballast addressing procedure 300 loops until a response to the query message of step 320 is received at step 322 or a second timeout expires at step 324. When the digital ballast controller 114 receives a response from a ballast 110 at step 322, the digital ballast controller 114 adds the ballast parameter to the ballast database at step 326. When the second timeout has expired at step 324, a determination is made at step 328 as to whether all of the ballast parameters of the present ballast have been collected. If not, the digital ballast controller 114 moves on to the next parameter in the database at step 330 and queries the ballast for this parameter at step 320. If the digital ballast controller 114 has all of the ballast parameters for the present ballast at step 328, a determination is made at step 332 as to whether all of the ballasts in the database have been queried for the parameters. If not, the digital ballast controller 114 moves on to the next ballast (i.e., the ballast having the next higher address in the database) at step 334, and moves to select the first parameter at step 336, before querying the next ballast for the first parameter at step 320. When the digital ballast controller 114 has collected all of the ballast parameters from all of the ballasts 110 at steps 328, 332, the procedure 300 exits.

Alternatively, the digital ballast controller 114 may not query for all of the ballast parameters at step 320, but may assume default values for some of the parameters. For example, if ballasts 110 are assigned a default high-end trim of 100% and a default low-end trim of 10% during production, the digital ballast controller 114 may assume during the ballast addressing procedure 300 that the high-end trim and low-end trim are at the default values of 100% and 10%, respectively.

If the digital ballast controller 114 fails, the ballast database built during the ballast addressing procedure 300 may be lost. According to the present invention, when the failed digital ballast controller 114 is replaced with a new digital ballast controller, the new digital ballast controller 114 is operable to rebuild the ballast database and save the ballast database in memory using a ballast database rebuilding procedure 350, which is shown in FIG. 3B. The ballast database rebuilding procedure 350 is preferably initiated by a command transmitted from the handheld infrared transmitter 122 or from the GUI software of the PC 150. The ballast rebuilding procedure 350 is very similar to the ballast addressing procedure 300 shown in FIG. 3A. However, in the ballast rebuilding procedure 350, the ballasts 110 are not assigned unique link addresses, as was completed in step 314 of the ballast addressing procedure 300. During the ballast database rebuilding procedure 350, the digital ballast controller 114 simply locates the ballasts 110 of the lighting control system 100 by transmitting a query to the ballasts at step 310 and adding the addresses of the responding ballasts to the ballast database at step 316. The digital ballast controller 114 then queries the ballasts 110 for all ballast parameters at steps 320-336.

Referring back to FIG. 2A, each of the motorized roller shades 104 comprises an electronic drive unit (EDU) 130. Each electronic drive unit 130 is preferably located inside the roller tube of the associated roller shade 104. The electronic drive units 130 are responsive to digital messages received from a wallstation 134 via a shade communication link 132. The user is operable to open or close the motorized roller shades 104, adjust the position of the shade fabric of the roller shades, or set the roller shades to preset shade positions using the wallstation 134. The user is also operable to configure the operation of the motorized roller shades 104 using the wallstations 134.

Preferably, up to 96 electronic drive units 130 and wallstations 134 are operable to be coupled to the shade communication link 132. A shade controller (SC) 136 is coupled to the shade communication link 132 and is operable to build a shade database using a procedure similar to the ballast database rebuilding procedure 302 shown in FIG. 3B. An example of a motorized window treatment control system is described in greater detail in commonly-assigned U.S. Pat. No. 6,983,783, issued Jan. 10, 2006, entitled MOTORIZED SHADE CONTROL SYSTEM, the entire disclosure of which is hereby incorporated by reference.

A plurality of lighting hubs 140 allow for communication between a personal computer (PC) 150 and the load control devices, i.e., the ballasts 110 and the electronic drive units 130. Each lighting hub 140 is operable to be coupled to one of the digital ballast controllers 114, which is coupled to the ballasts 110 on one of the digital ballast communication links 112. Each lighting hub 140 is further operable to be coupled to the shade controller 136, which is coupled to the motorized roller shades 114 on one of the shade communication links 114. The lighting hubs 140 and the PC 150 are coupled to an Ethernet link 152, such that the PC 150 is operable to transmit digital messages to the lighting hubs 140 via a standard Ethernet switch 154.

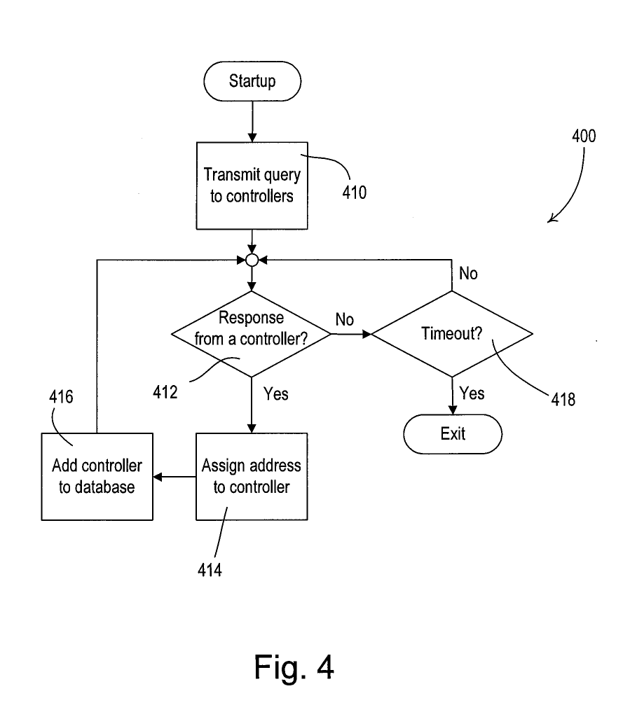

Upon startup, each lighting hub 140 is operable to automatically discover the controllers that are coupled to the lighting hub. FIG. 4 is a flowchart of a controller discovery procedure 400 executed by each of the lighting hubs 140 at startup. At step 410, the lighting hub 140 transmits a query message to all of the digital ballast controllers 114 and shade controllers 136 that are coupled to the lighting hub. Preferably, each controller that receives the query message responds by transmitting the controller type, i.e., whether the controller is a digital ballast controller 114 or a shade controller 136. If a response from a controller is received at step 412, the lighting hub 140 assigns a unique address to the controller at step 414. Next, the lighting hub 140 adds the address and the type of the controller (that responded at step 412) to a controller database at step 416. The lighting hub 140 continues to address the controllers (at step 414) and assign the addresses and types of the controllers to the controller database (at step 416) until a timeout expires at step 418, at which time, the procedure 400 exits.

The PC 150 executes a graphical user interface (GUI) software, which is displayed on a PC screen 156. The GUI allows the user to configure and monitor the operation of the lighting control system 100. During configuration of the lighting control system 100, the user is operable to determine how many ballasts 110, digital ballast controllers 114, electronic drive units 130, shade controllers 136, and lighting hubs 140 that are connected and active using the GUI software. Further, the user may also assign one or more of the ballasts 110 to a zone or a group, such that the ballasts 110 in the group respond together to, for example, an actuation of the wallstation 118. The PC 150 is operable to transmit an alert to the user in response to a fault condition, such as, a fluorescent lamp is burnt out. Specifically, the PC 150 sends an email, prints an alert page on a printer, or displays an alert screen on the PC screen 156.

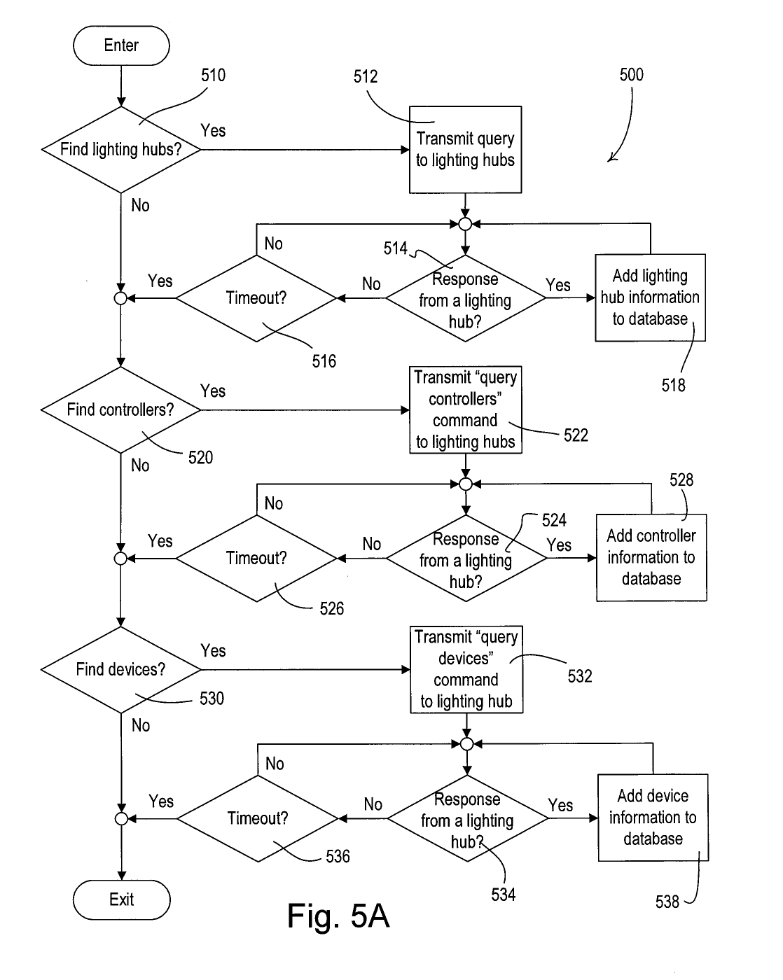

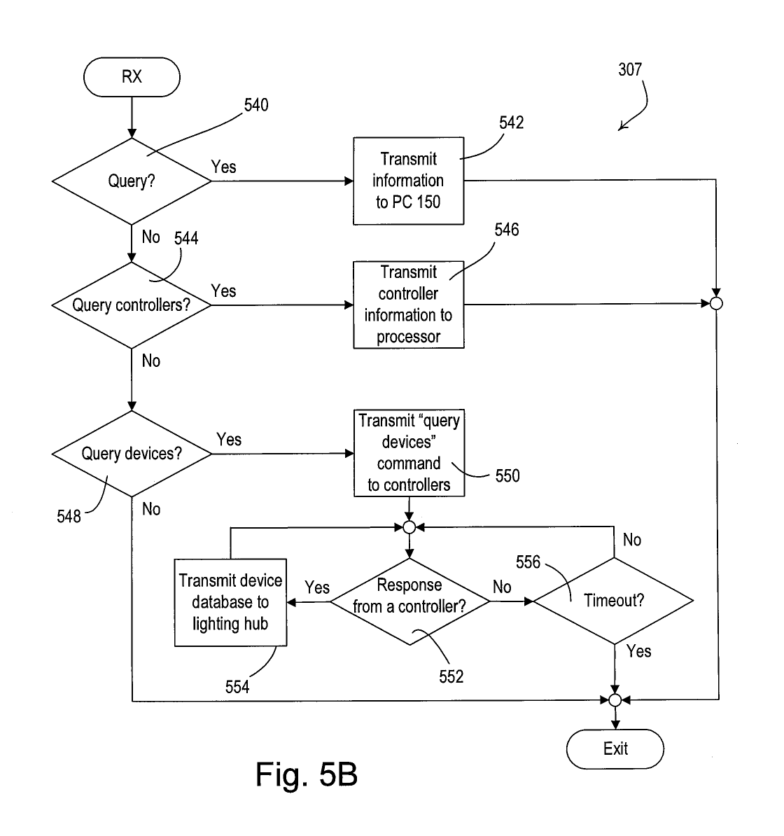

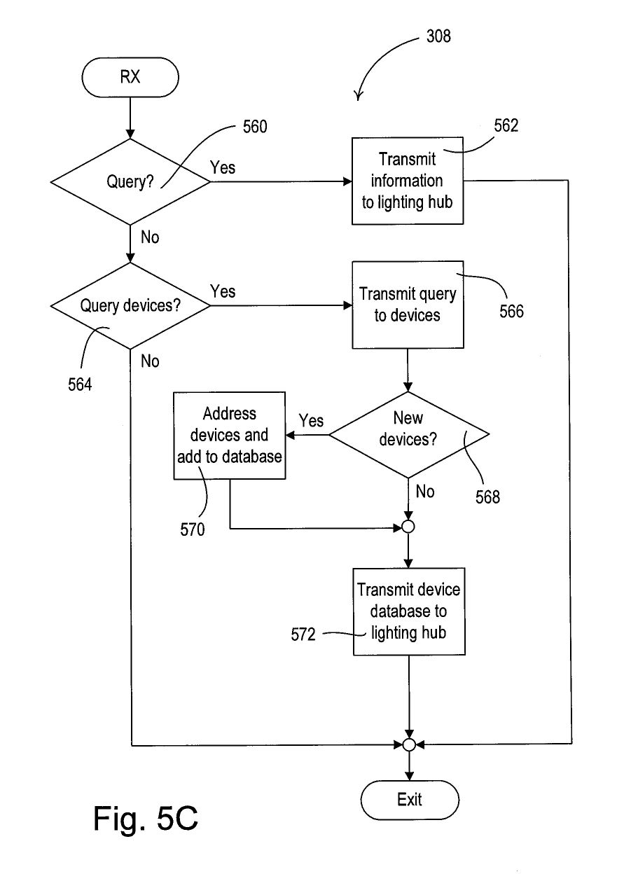

According to the present invention, the PC 150 is operable to execute an auto-discovery procedure (shown in FIGS. 5A, 5B, and 5C) to determine the number of lighting hubs 140, controllers (i.e., the digital ballast controllers 114 and the shade controllers 136), and devices (i.e., the ballasts 110, the electronic drive units 130, the shade wallstations 134, the ballast wallstations 118, the occupancy sensors, the daylight sensors, and the IR receivers 116), in the lighting control system 100. The PC 150 also determines other information (such as addresses and device type data) from the lighting hubs 140, the controllers, and the devices during the auto-discovery procedure. The PC 150 creates a database (i.e., a programming database) from the information collected from the auto-discovery procedure. Preferably, the user is operable to initiate the auto-discovery procedure from the GUI software.

FIG. 5A is a flowchart of a first auto-discovery procedure 500 executed by the PC 150 according to the present invention. FIG. 5B is a flowchart of a second auto-discovery procedure 502 executed by each of the controllers, i.e., the digital ballast controllers 114 and the shade controllers 136, of the lighting control system 100. FIG. 5C is a flowchart of a third auto-discovery procedure 504 executed by each of the devices, i.e., the ballasts 110, the electronic drive units 130, and the wallstation 134.

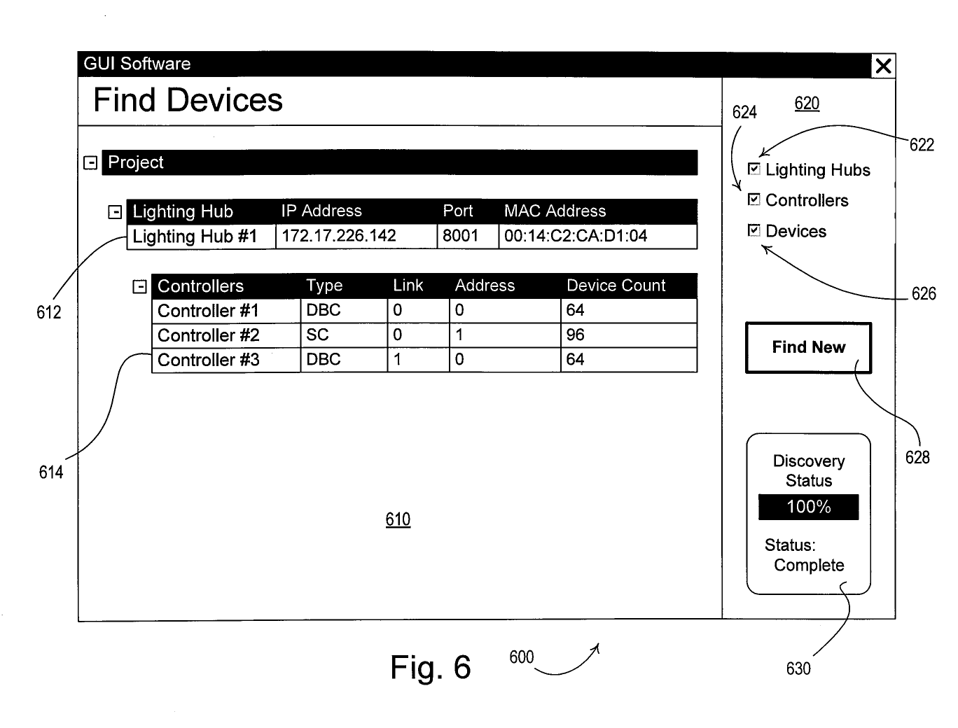

FIG. 6 is an example screen shot of an auto-discovery screen 600 of the GUI software. The auto-discovery screen 600 includes a project portion 610, in which the lighting hubs 140, controllers, and devices that are found by the auto-discovery procedure are listed. A lighting hub list 612 displays the name, the IP address, the port, and the MAC address of each lighting hub 140. A controller list 614 displays the name, the type, the link, the address, and the device count (i.e., the number of devices coupled to the controller) for each controller. A device list (not shown) displays information of each device and is provided on a different screen of the GUI software. An activity portion 620 of the auto-discovery screen 600 allows a user to initiate the auto-discovery procedure. Preferably, the user is operable to determine if the auto-discovery procedure should discover all lighting hubs, all controllers, and all devices by selecting the check boxes 622, 624, 626, respectively. The user is operable to start the first auto-discovery procedure 500 of the PC 150 by actuating the Find New button 628. The discovery status portion 630 provides feedback to the user of the progress and the status of the auto-discovery procedure.

Referring to FIG. 5A, the first auto-discovery procedure 500 begins when the user actuates the Find New button 628 of the auto-discovery screen 600. If the lighting hubs 140 should be discovered at step 510 (i.e., if the lighting hubs check box 422 is selected on the auto-discovery screen 400), the PC 150 transmits a query message to all of the lighting hubs 140 via the Ethernet link 152 at step 512. The procedure 500 loops until a response from a lighting hub 140 is received at step 514 or a third timeout expires at step 516. If the PC 150 receives a response from a lighting hub 140 at step 514, the PC adds the lighting hub information (i.e., the IP address, the port, and the MAC address of the lighting hub 140) to the database at step 518. As the PC 150 receives responses from the lighting hubs 140 at step 514, the PC continues to build the database of information about the lighting hubs at step 518 until the third timeout expires at step 516. The PC 150 uses a unique identifier for each new entry into the database.

If the lighting hubs are not selected to be discovered at step 510 or if the third timeout has expired at step 516, a determination is made at step 520 as to whether the controllers, i.e., the digital ballast controllers 114 and the shade controllers 136, should be discovered. If the controllers are selected to be discovered at step 520 (i.e., if the controllers check box 424 is selected on the auto-discovery screen 600), the PC 150 transmits a “query controllers” command to the lighting hubs 140 at step 522. At this time, the lighting hubs 140 that receive the “query controllers” command concurrently respond by transmitting controller information to the PC 150 as is described in further detail below with reference to FIG. 5B. When a response to the “query controllers” command is received by the PC 150 at step 524, the PC 150 adds the controller information to the database at step 528. The PC 150 continues to add the controller information to the database until a fourth timeout occurs at step 526.

If the controllers are not selected to be discovered at step 520 or if the fourth timeout has expired at step 526, a determination is made at step 530 as to whether the devices check box 626 is selected on the auto-discovery screen 600 and the devices (i.e., the ballasts 110, the electronic drive units 130, or the wallstations 134) should be discovered. If so, the PC 150 transmits a “query devices” command to the lighting hubs 140 at step 532. Accordingly, the lighting hubs 140 concurrently re-transmit the “query devices” command to the connected controllers, and the controllers that receive the “query devices” command concurrently transmit a query message to the connected devices as described in greater detail below with reference to FIGS. 5B and 5C. Responses to the “query devices” commands are relayed from the devices to the PC 150 through the controllers. The procedure 500 loops until a response is received by the PC 150 at step 534 or a fifth timeout expires at step 536. When the PC 150 receives a response at step 534, the PC adds the device information to the database at step 538. When the fifth timeout expires at step 536, the procedure 500 exits. Further, if the devices are not selected to be discovered at step 530, the procedure 500 exits.

The second auto-discovery procedure 502 (as shown in FIG. 5B) is executed by the lighting hubs 140 when the lighting hubs receive a communication from the PC 150 via the Ethernet link 152. If the lighting hub 140 receives a query message at step 540, the lighting hub transmits the IP address, the port, and the MAC address to the PC 150 at step 542 and the procedure 502 exits. If the lighting hub 140 has not received a query message at step 540, but the lighting hub has received a “query controller” command at step 544, the lighting hub 140 transmits the controller information determined from the controller discovery procedure 400 of FIG. 4 to the PC 150 at step 546 and the procedure 502 exits.

If the lighting hub 140 did not receive a “query controllers” command at step 544, a determination is made as to whether a “query devices” command has been received at step 548. If so, the lighting hub 140 re-transmits the “query devices” command to the controllers at step 550. The controllers will accordingly transmit the ballast database back to the lighting hub (as will be described in greater detail with reference to FIG. 5C). If a response from a controller is received at step 552, the lighting hub 140 transmits the ballast database to the PC 150 at step 554. When a seventh timeout expires at step 556, the procedure 502 exits. If the lighting hub 140 did not receive a “query devices” command at step 548, the procedure 502 exits.

The third auto-discovery procedure 504 (as shown in FIG. 5C) is executed by the controllers (i.e., the digital ballast controllers 114 and the shade controllers 136), when the controllers receive a communication from the lighting hubs 140. If the controller receives a query message at step 560 (e.g., during the controller discovery procedure 400 of FIG. 4), the controller transmits its address and type to the lighting hub 140 at step 562 and the procedure 504 exits.

If the controller has not received a query message at step 560, but the controller has received a “query devices” command at step 564, the controller transmits a query message to the devices coupled to the controller at step 566 to see if there are any new devices coupled to the link, i.e., devices that are not included in the ballast database (or the shade database) of the controller. If there are new devices at step 568, the controller assigns addresses to the devices and add the devices and their parameters to the ballast database (or shade database) at step 570. Preferably, the controller uses a procedure similar to the ballast addressing procedure 300 during step 570. If there are no new devices at step 566 or after the new devices are added to the database at step 570, the ballast database (or the shade database) is transmitted to the lighting hub 140 (which re-transmits the database to the PC 150) at step 572. Specifically, the contents of the ballast database (or the shade database) are transmitted to the lighting hub 140 one-by-one at step 572, which re-builds the ballast database (or the shade database) after receiving the individual transmissions. Finally, the procedure 504 exits.

The auto-discovery procedure of FIGS. 5A-5C can be re-executed after previously being executed. For example, the user may initiate the auto-discovery procedure to update the programming database on the PC 150 or if new devices have been added to the lighting control system 100. The GUI software may allow the user to limit the auto-discovery procedure to a subset of the lighting hubs 140, controllers, and devices in the system. Accordingly, the user many desire to only discover the ballasts 110 connected to a specific digital ballast controller 114. Preferably, the user would be operable to select either the entire system or specific lighting hubs 140, controllers, and devices to be auto-discovered using the GUI software. For example, the user could select Controller #4 on the controller list 614 of the project portion 610 of the auto-discovery screen 600.

As previously noted, the user is operable to use the GUI software of the PC 150 to configure the lighting control system 100. The user is further operable to use the handheld remote control 122 to configure the operation of the ballasts 110 and to use the wallstation 134 on the shade communication link 132 to configure the operation of the electronic drive units 130. Accordingly, the PC 150 is operable to extract the configuration information from the ballasts 110 and the electronic drive units 130 to build or update the programming database as described with reference to FIGS. 5A-5C. According to the present invention, the PC 150 is also operable to transmit updated portions of the database to the devices when the user uses the GUI software to configure or modify the operation of the lighting control system 100.

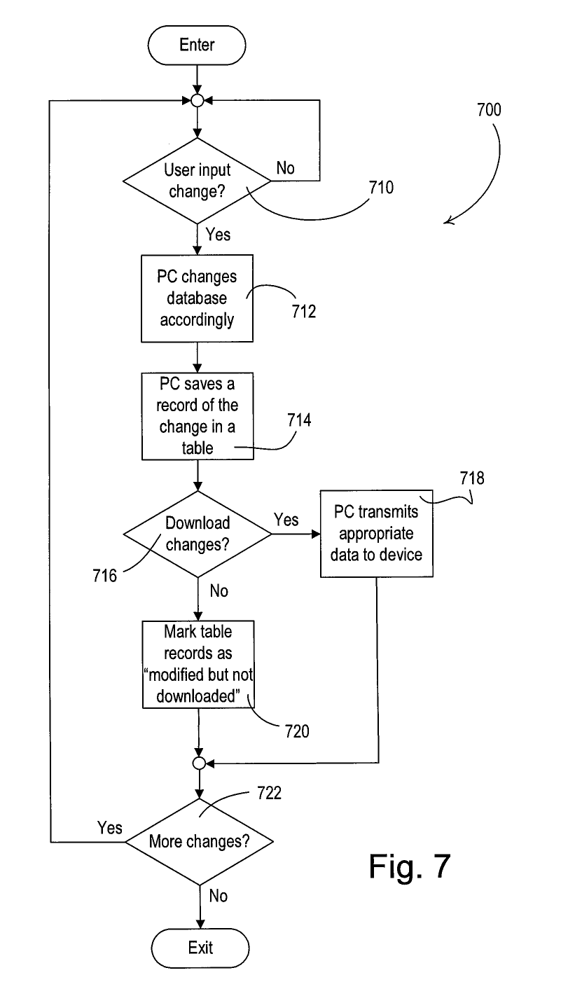

FIG. 7 is a flowchart of a database update procedure 700 executed by the PC 150. The database update procedure 700 is executed when the user desires to update the programming database, i.e., to change the operation of the lighting control system 100. The database update procedure 700 first waits until the user inputs a system change to the GUI software at step 710. When the user inputs a change at step 710, the PC 150 accordingly changes the programming database at step 712. At step 714, the PC 150 saves a record of the changes that were made to the database in memory. Accordingly, the PC 150 is operable to generate a report at a later time of all changes made to the lighting control system 100 over a period of time.

Next, the user is operable to decide whether to download the changes to the appropriate devices that were affected by the changes at step 716. For example, the GUI software may provide a “Download Now” button that the user can actuate to download the changes to the devices. If the user desires to download the changes to the devices at step 716, the PC 150 transmits the appropriate data, i.e., the appropriate portion of the database, to the affected devices at step 718. The lighting hubs 140 and controllers accordingly relay the transmitted data to the appropriate devices. Upon receiving the transmitted data, the devices simply overwrite the programming information stored in memory with the updated database portion.

If the user chose not the download the changes to the devices at step 716, the PC 150 marks the changes that were not downloaded in the record of the table of changes (from step 714) as “modified, but not downloaded”, i.e., that the changes were not downloaded to the appropriate devices, at step 720. Preferably, those changes that were not downloaded to the devices are highlighted in the report that is generated by the PC 150. If the user desires to make more changes to the operation of the lighting control system 100 at step 722, the procedure 700 loops, such that the user is operable to make another change at step 710. Otherwise, the procedure 700 exits.

While the present invention has been described with reference to the lighting control system 100 having a plurality of ballasts 110 for controlling the intensities of fluorescent lamps 102, the present invention is not limited to lighting control systems for controlling only fluorescent lamps. The concepts of the present invention can be applied to load control systems for any type of lighting load (such as, for example, incandescent lamps, electronic low-voltage (ELV) loads, magnetic low-voltage (MLV) loads, and non-dim loads) or other electrical load (such as, for example, fan motors and AC motorized window treatments).

Although the present invention has been described in relation to particular embodiments thereof, many other variations and modifications and other uses will become apparent to those skilled in the art. It is preferred, therefore, that the present invention be limited not by the specific disclosure herein, but only by the appended claims.

What is claimed is:

1. A method of building a database of a load control system having a plurality of control devices, each characterized by an address and a type, the method comprising the steps of:
transmitting a query message to the plurality of control devices;
receiving device information of one of the plurality of control devices in response to the query message, the device information including the address and the type of the control device; and
storing the addresses and types of the plurality of control devices in the database.

2. The method of claim 1, further comprising the steps of:
transmitting a first parameter query message to a first control device having a first address stored in the database;
receiving a response to the first parameter query message, the response to the first parameter query message including a first parameter for the first control device having the first address; and
storing the first parameter for the first control device having the first address in the database.

3. The method of claim 2, further comprising the steps of:
transmitting a second parameter query message to the first control device having the first address stored in the database;
receiving a response to the second parameter query message, the response to the second parameter query message including a second parameter for the first control device having the first address; and
storing the second parameter for the first control device having the first address in the database.

4. The method of claim 2, further comprising the steps of:
transmitting a first parameter query message to a second control device having a second address stored in the database;
receiving a response to the first parameter query message from the second control device, the response to the first parameter query message including a first parameter for the second control device having the second address; and
storing the first parameter for the second control device having the second address in the database.

5. The method of claim 1, wherein the control devices comprise a plurality of lighting hubs, a plurality of controllers, and a plurality of devices.

6. The method of claim 5, wherein the step of transmitting a query message to the plurality of control devices comprises the steps of:
transmitting a first query message to the plurality of lighting hubs;
transmitting a second query message to the plurality of controllers; and
transmitting a third query message to the plurality of devices.

7. The method of claim 5, wherein the step of transmitting a query message to the plurality of control devices comprises the steps of:
transmitting a first query message to a first subset of the plurality of controllers; and
simultaneously transmitting a second query message to a second subset of the plurality of controllers.

8. The method of claim 1, further comprising the step of:
using a graphical user interface to initiate the step of transmitting a query message to the plurality of control devices.

9. The method of claim 8, further comprising the step of:
selecting a subset of the plurality of control devices using the graphical user interface;
wherein the step of transmitting a query message to the plurality of control devices comprises transmitting the query message to the subset of the plurality of control devices.

10. A control device for a load control system having a plurality of control devices, each characterized by an address and a type, the control device comprising:
means for transmitting a query message to the plurality of control devices;
means for receiving device information of one of the plurality of control devices in response to the query message, the device information including the address and the type of the one of the plurality of control devices; and
means for storing the addresses and types of the plurality of control devices in the database.

11. The control device of claim 10, wherein the control device comprises a power supply of the lighting control system.

12. A method of building a system programming database defining the operation of a load control system including a server operable to communicate with a plurality of controllers, each of the controllers coupled to a plurality of control devices, each characterized by a respective device parameter, the method comprising the steps of:
transmitting a first query message from each of the controllers to each of the plurality of control devices;
transmitting the device parameter of each of the plurality of control devices to the controllers in response to the query messages;
adding the device parameter of the each of the plurality of control devices to partial programming databases stored in each of the controllers;
transmitting a second query message from the server to each of the controllers;
transmitting the partial programming database of each of the controllers to the server; and
adding the device parameters of the partial programming databases to the system programming database.

13. The method of claim 12, wherein the load control system further comprises a lighting hub coupled to the server and the plurality of controllers, the method further comprising the steps of:
adding the address and type of each of the controllers to a controller database;
transmitting a third query message from the server to the lighting hub prior to the step of transmitting a second query message from the server to each of the controllers;
transmitting the controller database from the lighting hub to the server; and
adding the address and type of the controller database to the system programming database.

14. The method of claim 13, further comprising the step of:
using a graphical user interface of the server to initiate the step of transmitting a third query message from the server to the lighting hub.

15. The method of claim 14, further comprising the step of:
selecting a subset of the plurality of control devices using the graphical user interface;
wherein the step of transmitting a query message to the plurality of control devices comprises transmitting the query message to the subset of the plurality of control devices.

16. The method of claim 12, wherein the load control system further comprises a plurality of lighting hubs coupled to the server, each of the plurality of lighting hubs coupled to a subset of the plurality of controllers, and wherein the step of transmitting a second query message from the server to each of the controllers further comprises the steps of:
transmitting the second query message from the server to each of the lighting hubs; and
concurrently transmitting the second query message from each of the lighting hubs to the controllers.

17. A load control system comprising:
a plurality of control devices, each characterized by a respective device parameter;
a plurality of controllers, each of the control devices coupled to one of the plurality of controllers, each of the controllers operable to transmit a first query message to each of the control devices, receive the device parameters from each of the control devices, and add the device parameters to a partial programming database; and
a server executing a graphical user interface software and operable to communicate with the plurality of controllers, the server operable to transmit a second query message to each of the controllers, receive the partial programming databases from each of the controllers, and add the device parameters of the partial programming databases to a system programming database.

18. The load control system of claim 17, further comprising:
a lighting hub coupled to the server and the plurality of controllers, the lighting hub operable to add the address and type of each of the controllers to a controller database, receive a third query message from the server, and transmit the controller database to the server;
wherein the server is operable to receive the controller database and to add the address and type of the controller database to the system programming database.
